(19) United States
(12) Patent Application Publication
(10) Pub. No.: US 2013/0255507 A1
(43) Pub. Date: Oct. 3, 2013

(54) SYSTEM FOR THERMALLY CONDITIONING AN OBJECT, CONDITIONING METHOD

(71) Applicants: Hugo Meunier, Luxembourg (LU); Manon Meunier, Chenove (FR)

(72) Inventors: Hugo Meunier, Luxembourg (LU); Manon Meunier, Chenove (FR)

(21) Appl. No.: 13/878,989

(22) PCT Filed: Oct. 11, 2011
(86) PCT No.: PCT/FR2011/000549

§ 371 Date: Jun. 12, 2013

(30) Foreign Application Priority Data
Oct. 11, 2010 (FR) 10/04009

(51) Int. Cl. A47J 27/00

(52) U.S. Cl. CPC A47J 27/002
USPC 99/325

(57) ABSTRACT

The invention concerns a system for hot or cold thermal conditioning a food preparation intended for all types of catering premises and comprising at least one jar-type object containing the said food preparation and comprising at least one RFID marker, and a conditioning machine equipped with conditioning means coupled to command means and comprising control means equipped with at least one RFID marker suitable for reading the data from said RFID marker the said control means being coupled to the command means and arranged so as to authorize conditioning of the food preparation only if the RFID receiver the data carried by the RFID marker and the latter data are consistent with the previously established data recorded using the said control means.

### TECHNICAL FIELD

The present invention concerns a system for thermally conditioning an object, and in particular a receptacle containing a food preparation. The invention also concerns a process for thermally conditioning at least one object. In the present application, the term “thermal conditioning” refers to the process of raising or reducing temperature. It can also refer to reheating, for example for cooking purposes. It may also refer to cooling, for example for freezing purposes.

### PRIOR ART

There are numerous conditioning machines used for example to heat food preparations, such as microwave devices and steam cookers. These machines are designed for use in restaurants, by collective catering services or by individuals. These machines can also be made available in, for example, free catering areas, businesses or hotels. In this way, employees or persons passing through can use the conditioning machines to reheat their meals, whether the meal is brought in from outside or purchased on site. In particular, hotel rooms can be individually equipped with this type of machine. It is however impossible, with such machines offered on free service, to monitor their use and limit it to the conditioning of items provided for that purpose. In addition, it is also no longer possible to ensure that meals reheated are suitable for consumption. Finally, these machines offered on free service do not allow their use to be limited to reheating of dishes sold in the place of consumption or more generally guarantee the quality or origin of the reheated dishes. Persons are therefore free to bring their own dishes and reheat them using these machines offered on free service. This can cause a considerable loss of income, for example for hotels without a restaurant service or with limited opening hours.

### SUMMARY OF INVENTION

The present invention is designed to overcome these problems by proposing a device for thermally conditioning an object and a procedure for thermally conditioning an object, and to guarantee the origin and the quality of the objects conditioned, especially in the case of food preparations to be reheated.
The invention concerns a system for cold or hot thermal conditioning of a food preparation intended for all kinds of catering premises and comprising at least one jar-type object containing the said food preparation and containing at least one RFID marker, and a conditioning machine equipped with conditioning means coupled to command means and containing control means equipped with at least one RFID receiver suitable for reading the data from the said RFID marker, the said control means being coupled to the said command means and arranged so as to authorise only the conditioning of the food preparation if the RFID receiver recognises the data borne by the RFID marker and the latter data are consistent with data previously established and recorded by the said control means, these data borne by the RFID marker comprising at least one of the following items of information:identification of the said object and/or of its contents;
deadline for consumption/use of the said object and/or of its contents;
the number of conditioning processes previously undergone by the said object using the conditioning machine;
the origin of the said object and/or its contents;
the recommended conditioning time of the said object (2) and its contents;

the said system allowing the use of the conditioning machine to be controlled in the catering location and the use to be limited to conditioning of objects provided for that purpose in order to guarantee the quality and origin of the food preparations to be conditioned.

Further on in the description, the term RFID (Radio Frequency Identification in English or Radio-Identification in French) refers to an electronic smart card that comprises a miniature electronic circuit. The term RFID transmitter refers to a transmitter that uses RFID technology and is suitable for transmitting information that allows parameterisation of a RFID smart card.

The term RFID receiver refers to a receiver that uses RFID technology and is suitable for recognising and reading data contained in a RFID smart card.

The object may be equipped with at least one label bearing the RFID marker. The object may also contain at least one RFID marker integrated into the object.

According to a preferred method of realisation, the conditioning means comprise at least one conditioning machine chosen from the group comprising at least one steam cooker and one item of deep-freezing equipment.

Beneficially, the control means comprise at least one internal clock and are arranged so as to prevent the conditioning means from being started when the date of use of the conditioning machine, detected by the RFID receiver, is later than the consumption deadline date borne by the RFID marker in the object.

The conditioning machine preferably contains at least one RFID marker suitable for increasing during each conditioning cycle the number of conditionings previously undergone by the object in the conditioning machine and borne by the said RFID marker, and the control means are preferably arranged so as to prevent the conditioning means from being started when the number of conditionings previously undergone in the conditioning machine reaches a pre-determined value recorded by the control means.

The control means are beneficially arranged so as to make the conditioning means function during the recommended time borne by the RFID marker in the object and detected by the RFID receiver.

Of particular benefit, the device according to the invention comprises a number of conditioning machines and a number of objects.

The control means are beneficially equipped to limit the operating time of the conditioning means to the conditioning time recommended for the object, this recommended conditioning time being contained in the RFID marker and detected by the RFID receiver in the conditioning machine.

### SUMMARY DESCRIPTION OF DRAWINGS

The invention is described below, as shown in the attached drawings by way of a non-limiting example, wherein:

FIG. 1 is a schematic view of the system for thermally conditioning the object according to the invention before the conditioning stage, the conditioning machine and the object to be conditioned being depicted separately;

FIG. 2 is a schematic view of the system for thermally conditioning the object according to the invention during the conditioning stage, during which the object to be conditioned is received within the conditioning machine.

### PREFERRED EMBODIMENT(S) OF THE INVENTION

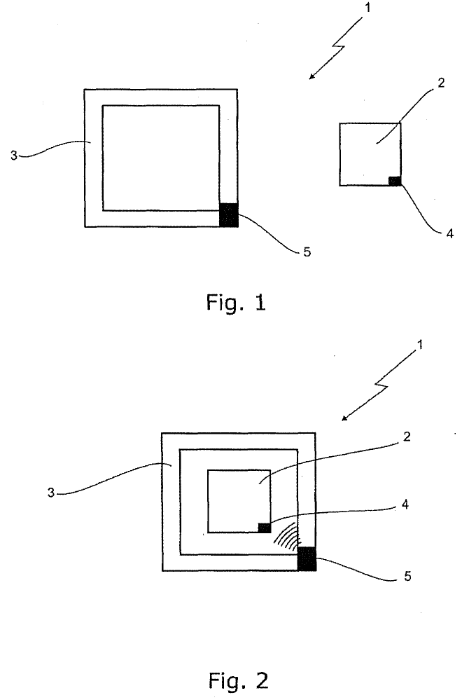

With reference to FIGS. 1 and 2, the system 1 for thermally conditioning the object according to the invention comprises a conditioning machine 3 and at least one jar 2 containing a food preparation and forming the object to be thermally conditioned. In this example, the conditioning machine 3 is a steam cooker of the traditional type, shown schematically as a double rectangle. This type of conditioning machine 3 allows effective heating of the food preparation while retaining its quality of taste.

The jar 2 may, for example, be made of glass and contains a RFID marker 4, in this example sunk into the glass. The RFID marker 4 comprises a silicon smart card, an aerial and a substrate and/or encapsulating layer (not shown in the drawings). The aerial enables the RFID marker 4 to receive and respond to the radio requests issued from a RFID transmitter-receiver. The RFID 4 marker may therefore store different data and authorise their access for reading and/or writing purposes. These data, for example, relate to the food preparation contained in the jar 2, such as its identification, composition, date of preparation, packaging date, origin, consumption deadline and recommended conditioning time. The RFID marker 4 may also store, and allow access for reading and writing purposes to data relating to the jar 2 itself, such as, for example, the number of conditionings previously undergone by the jar 2 in the conditioning machine 3. Each jar 2 is beneficially provided with a lid, which may for example be shaped in a way similar to the covers used in higher-class restaurants.

The conditioning machine 3 comprises a closed area within which a container, for example a jar 2, may be positioned. The conditioning machine 3 comprises conditioning means (not illustrated), such as a bain-marie. These conditioning means are coupled to command means (not illustrated) suitable for commanding the operation of the conditioning means to bring about the conditioning (raise of temperature) of the jar 2 and in particular of its contents. The conditioning machine 3 also comprises control means 5 containing at least one RFID receiver and suitable for reading the data from the RFID marker 4.

The control means 5 are coupled to command means in order to authorise conditioning only under certain conditions, such as, for example:
If the consumption date was not exceeded.
A previously established number of reheating processes is not exceeded.

In order to verify that the consumption expiry date has not passed, the control means 5 contain an internal clock and comparison means that allow the date of the internal clock and the consumption expiry date borne by the RFID marker 4 and detected by the RFID receiver 5 to be compared.

The conditioning machine 3 also contains a RFID transmitter suitable for increasing, on each conditioning cycle, the number of conditioning operations previously undergone as recorded in the RFID marker 4 on the jar 2. Therefore, in order to verify that the previously established number of heating processes has not been exceeded, the comparison means verify that the number of conditioning processes previously undergone by the jar 2, the number borne by the RFID marker 4 and detected by the RFID receiver 5, does not reach the set limit.

The control means are provided either automatic or semi-automatic. In the first case, once the jar 2 is received in the enclosed area of the conditioning machine 3, and the control means 5 have verified that the operating conditions are fulfilled, conditioning starts automatically. A time period may be provided before conditioning starts. In the second case, the conditioning machine 3 is equipped with a switch (not illustrated) that may include a light which illuminates when the operating conditions are fulfilled. The user is then free to start the conditioning process by pressing this switch. A time period may also be provided to turn off the switch after a given lapse of time and thus prevent the conditioning machine 3 from being left for too long with its switch illuminated without being used. The conditioning cycle (control and conditioning) may be reinitiated by the user by removing the jar 2 from the enclosed area and placing it back in that area.

The control means 5 are suitable for detecting the recommended conditioning time, the time borne by the RFID marker 4 and detected by the RFID receiver 5, and for making the conditioning machine 3 run for a period that corresponds to this recommended conditioning time.

It follows hereinafter a description of the thermal conditioning process implemented in the system described above. This process is used, for example, in a hotel with rooms equipped individually with conditioning machines 3. A choice of jars 2 containing different food preparations can be offered at the hotel reception desk or in an automatic distributor provided at the reception desk. Each person is therefore free to take a jar 2 of their choice for reheating in their bedroom. The user removes the lid from the jar 2 and places the jar 2 in the conditioning machine 3. The RFID receiver 5 in the conditioning machine 3 then recognises the RFID marker 4 in the jar 2. During this recognition stage, the control means 5 verify the consumption expiry date and the number of conditioning processes previously undergone by the jar 2 in a conditioning machine 3 of the same type. During this same recognition stage, the control means 5 record the recommended conditioning time.

If the consumption expiry date borne by the RFID marker 4 and detected by the RFID receiver 5 is surpassed by the date of the internal clock in the conditioning machine 3, then the control means 5 will prevent the conditioning process from starting. This therefore prevents food preparations which best-before date has expired from being reheated for consumption. Similarly, if the number of conditioning processes previously undergone, as recorded in the RFID marker 4 for the jar 2 and detected by the RFID receiver 5 is exceeded, the control means 5 prevent the conditioning process from starting. This therefore prevents people from keeping jars 2 to fill them with their own food preparations without buying the jars 2 offered by the hotel. The origin and the quality of the contents of the jars 2 are therefore guaranteed. It is clearly understood that the number of conditioning processes undergone by the object 2 takes into account all prior conditioning processes carried out by any similar conditioning machine 3.

When the consumption date and the number of conditioning processes previously undergone, as verified by the RFID received 5 in the conditioning machine 3, fulfil the previously established conditions, the control means 5 allow the conditioning process to start. In the case of an automatic conditioning machine 3, the control means 5 act directly to trigger the conditioning means. In the case of a semi-automatic conditioning machine, the control means 5 close off a portion of the circuit, which, when the user presses the switch, enable the conditioning means to be started.

During the conditioning process, for example at the beginning, the RFID transmitter on the conditioning machine 3 gives off an increment signal which, once received by the RFID marker 4 in the jar 2, increases the recorded number of conditioning processes previously undergone by the jar 2. This increased number can thus be verified before the jar 2 next undergoes a conditioning process, to limit the number of occasions on which the said jar 2 is reused.

The conditioning means continue to function during the recommended conditioning time detected by the control means 5. The food preparation can thus be subjected to an optimal conditioning time. Circuit-breaking means (not illustrated) can be included in the conditioning machine 3 in order to stop or interrupt the conditioning process if the jar 2 is removed from the enclosed area.

Optionally, the conditioning machine 3 may contain means for measuring the temperature and thus allowing the maximum conditioning temperature to be controlled. The control means 5 can authorise successive activation of the switch over a previously defined time period, in order to launch two successive conditioning processes. In this case, the temperature control means can be used to detect the temperature of the jar 2 after the first conditioning process and thus adapt the duration of the second conditioning process. Successive conditioning processes are useful, for example, when the user is interrupted in the preparation process after the conditioning process starts, for example if he receives a phone call. If the interruption is long, the user can thus recondition the jar. He can thus eat the food preparation at an optimal temperature without it cooling down.

### Other Embodiments

In an alternative embodiment (not illustrated), the jar contains a label that in turn contains the RFID marker. This label, known as a radio-label, may for example be stuck to the object.

In other embodiments (not illustrated), the system for thermally conditioning the object contains any other means of conditioning, such as for example a microwave device or deep-freezer. Thus, the system for thermally conditioning the object, according to the invention, may be used to heat but also to cool an object. In certain cases, the admissible number of conditioning processes undergone is one only. In these cases, the object may only be conditioned once. This particular configuration will for example be used when a simple conditioning process renders the object unsuitable for consumption or use subsequently.

### INDUSTRIAL APPLICABILITY

The thermal conditioning system 1 according to the invention may be used to condition any type of object 2, for example containers of do-it-yourself components, for maintenance when the components have to be used at given temperatures different from the ambient temperature.

As detailed above, this system 1 may beneficially be used to condition jars 2 containing food preparations. The conditioning machines 3 may thus be made available, for example in hotel rooms, and the jars 2 may be distributed at the reception desk to enable each person, regardless of time, to prepare a hot meal.

It is clearly understood that the examples described are merely specific illustrations and in no circumstances limit the fields of application of the invention. The person skilled in the art can make changes to the size, shape and material to the specific embodiment and in the installation procedure, without however stepping outside the scope of the present invention.

1. System for hot or cold thermal conditioning of a food preparation intended for all kinds of catering premises, comprising
at least one jar-type object containing the said food preparation and further comprising at least one RFID marker, and a conditioning machine equipped with conditioning means coupled to command means and comprising control means equipped with at least one RFID receiver suitable for reading data from the RFID marker, the control means being coupled to the command means and arranged to authorize conditioning of the food preparation only if the RFID receiver recognizes the data borne by the RFID marker and the latter data are consistent with pre-established data recorded by the control means, wherein data borne by the RFID marker contains at least one of the following items of information:
identification of the object and of its contents;
deadline for use of the object and of its contents;
the number of conditioning processes previously undergone by the object using the conditioning machine;
the origin of the object and its contents;
the recommended conditioning time of the object and its contents;
the system allowing the use of the conditioning machine to be controlled in the catering location and the use to be limited to conditioning of objects provided for that purpose in order to guarantee the quality and origin of the food preparations to be conditioned.

2. System according to claim 1, wherein:
the object is equipped with at least one label containing the RFID marker.

3. System according to of claim 1, wherein:
the object contains at least one RFID marker integrated into the object.

4. (canceled)

5. System according to claim 1, wherein:
the conditioning means further comprises at least one conditioning machine that can be at least one of:
A steam cooker
A deep-freezing device.

6. System according to claim 1, wherein:
the control means further comprise at least one internal clock and in that they are arranged to prevent the conditioning means from being started when the date of the day of use of the conditioning machine, detected by the RFID receiver, has surpassed the expiry date of consumption borne by the RFID marker in the object.

7. System according to claim 1, wherein:
the conditioning machine contains at least one RFID transmitter suitable for increasing, at each conditioning cycle, the number of conditioning cycles previously undergone by the object in the conditioning machine and borne by the RFID marker, and in that the control means are arranged to prevent the conditioning means from being started when the number of conditioning processes previously undergone by the object reaches a previously determined value recorded by the control means.

8. System according to claim 1, wherein:
the control means are arranged to operate the conditioning means during the recommended conditioning time borne by the RFID marker on the object and detected by the RFID receiver.

9. System according to claim 1, wherein:
it contains more than one conditioning machine and more than one object.

10-12. (canceled)
